(19) United States
(12) Patent Application Publication
(10) Pub. No.: US 2016/0048883 A1
(43) Pub. Date: Feb. 18, 2016

(54) System and Method for Distributed Advertising

(71) Applicant: Vertical Computer Systems, Inc., Richardson, TX (US)

(72) Inventor: Luiz Claudio Valdetaro, Coppell, TX (US)

(73) Assignee: VERTICAL COMPUTER SYSTEMS, INC., Richardson, TX (US)

(21) Appl. No.: 14/633,006

(22) Filed: Feb. 26, 2015

Related U.S. Application Data
(63) Continuation-in-part of application No. 12/966,741, filed on Dec. 13, 2010, now Pat. No. 9,112,832.
Application No. 12/966,741 is a continuation-in-part of application No. 13/951,252, filed on Jul. 25, 2013.
Application No. 13/951,252 is a continuation-in-part of application No. 13/491,372, filed on Jun. 7, 2012.
(60) Provisional application No. 61/944,684, filed on Feb. 26, 2014.
(60) Provisional application No. 61/494,407, filed on Jun. 7, 2011.

(51) Int. Cl. G06Q 30/02; G06Q 50/00

(52) U.S. Cl. CPC G06Q 30/0269; G06Q 30/0277; G06Q 50/01

(57) ABSTRACT

A server computer coupled to a distributed advertising system network has a web server adapted for running a web application having access to advertiser metadata and other advertiser data. A client computer coupled to the network includes first software configured to collect and save in first memory user data locally in a user device, but not send that data to the server computer, second software configured to download via the network from the web server and save in a first memory advertiser metadata in a manner where the entire advertiser metadata file needs to be downloaded every time, and third software configured, when accessing a website or social network, to match local data against the local copy of advertiser metadata residing at the user's device, and if there are desirable advertisers to display, to download parts of the other advertiser data related to those advertisers and display targeted ads.

### CROSS-REFERENCE TO RELATED APPLICATIONS

This application claims the benefit of application Ser. No. 61/944,684 filed Feb. 26, 2014, and is a continuation-in-part (CIP) application of prior application Ser. No. 12/966,741 filed Dec. 13, 2010, and is a CIP application of prior application Ser. No. 13/951,252 filed Jul. 25, 2013, which is a CIP of application Ser. No. 13/491,372 filed Jun. 7, 2012, which claims benefit of application Ser. No. 61/494,407 filed Jun. 7, 2011, all of which applications are hereby incorporated herein by reference, in their entirety.

### TECHNICAL FIELD

The invention relates generally to advertising, and more particularly, to Mobile Internet Devices (“MID”), or distributed, advertising.

### BACKGROUND

With reference to FIG. 1, conventionally, websites and social networks provide advertising by collecting as much data as possible from user devices 102, and serving ads through an advertising network based on the collected data. Data is collected from users 102 utilizing three primary methods. The first method of collecting data consists of tracking, whether by location (through IP address or GPS), browsing history of pages visited by the user (through cookies 110), or user behavior through “likes”, “friends” and groups joined as typically found on social networks or products purchased or viewed (through tracking software of users who maintain an account (such as Amazon®) or a social network (i.e., Facebook®)). The second method of collecting data is through a collection of information provided by the user to register an account for a social network or a website. This data is provided by the user and includes demographic information such as age, gender, marital status, field of work, and so forth, which is used to build a profile. A third method is by collecting information from users' computers in the form of web “cookies” that a website later can use.

With all of this collected data on users, websites and social networks then match that information against the data in an advertiser database. The advertiser database will use its own metadata 118, such as the field of the advertiser, location, products, times of operation, and the like, plus actual data concerning products and services (such as description of products, pictures, etc.). Once the user data 116 is matched with products or services, the website or social network will display relevant ads to individual users.

There are significant privacy and security issues associated with the conventional approach to collecting advertising data. In terms of security, user information (including profile information and browsing history) may be compromised by the centralized data website and social media that companies use to store data. With respect to privacy, users may fear that shared data may be misused. Many users may fear sharing their data even to the point of providing false information. These concerns are balanced against advertisers having the means to serve users with relevant ads.

In view of the foregoing, there is a need for a system and method for resolving privacy and security issues associated with the conventional approach to collecting advertising data.

### SUMMARY

The present invention, accordingly, provides a distributed advertising system having a network. A server computer coupled to the network has a web server adapted for running a web application having access to advertiser metadata and other advertiser data. A client computer coupled to the network includes first, second, and third software. First software is configured to collect and save in first memory user data locally in a user device, but not send that data to the server computer. Second software is configured to download via the network from the web server and save in a first memory advertiser metadata in a manner where the entire advertiser metadata file needs to be downloaded every time. Third software is configured, when accessing a website or social network, to match local data against the local copy of advertiser metadata residing at the user's device, and if there are desirable advertisers to display, to download parts of the other advertiser data related to those advertisers and display targeted ads.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic view of a distributed advertising system embodying features of the prior art; and

FIG. 2 is a schematic view of a distributed advertising system embodying features of the present invention.

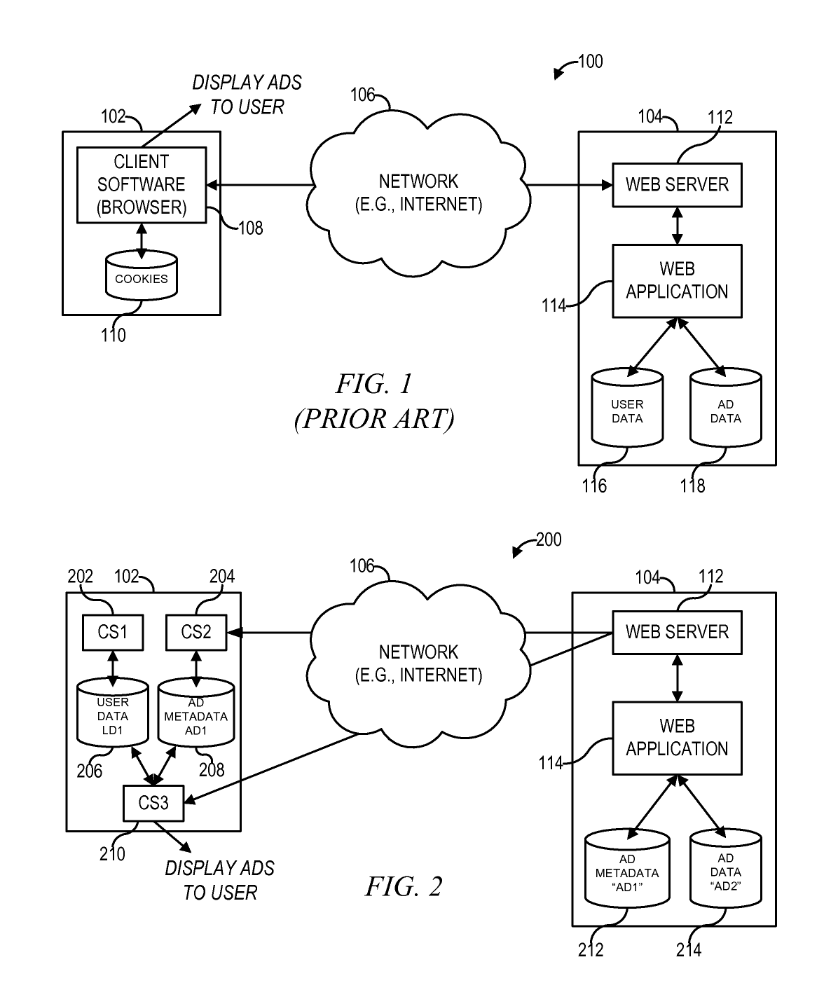

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning the Internet, web servers, web applications, and the like have been omitted inasmuch as such details are not considered necessary to obtain a complete understanding of the present invention, and are considered to be within the skills of persons of ordinary skill in the relevant art. Additionally, as used herein, the term “substantially” is to be construed as a term of approximation.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

Referring to FIG. 2 of the drawings, the reference numeral 200 generally designates a distributed advertising system embodying features of the present invention. The system 200 includes client, or user, computer 102 coupled to server computer 104 via network 106, such as the Internet.

In accordance with principles of the present invention, there are preferably four parts of the invention that are required to resolve issues of privacy and security. The first part is to split the advertiser database into two parts: one part 212 will contain only some minimal data about the advertiser (name, description) (referred here as “AD1”), including all the advertiser's metadata. The second part 214 of the advertisers' data is all the remaining data of that advertiser (referred to herein as “AD2”, which may be voluminous). Both sets of data reside in a centralized server 104. The key point here is that AD1 will not be very large in size.

The second part of what is needed to resolve issues of privacy and security is a software solution 202 (referred to herein as “CS1”) that will collect the user's data locally in the user's device 102 (e.g., a smartphone, tablet, or computer), but not send that data to the centralized server 104. For purposes of this invention, user local data will be referred to as “LD1” 206.

The third part of what is needed to resolve issues of privacy and security is software 204 (referred to herein as “CS2”) that will download the AD1 from the centralized server 104 in a manner where the entire AD1 file 212 needs to be downloaded every time. The invention could, for example, download the whole AD1 file 212 the first time and only download updates as changes occur in the centrally located AD1.

A fourth part of what is needed to resolve issues of privacy and security is software 210 (referred to herein as “CS3”) that will, when accessing that website or social network, match LD1 against the local copy of AD1 residing at the user's device 102. After matching it, if there are desirable advertisers to display, it can download parts of the AD2 database 214 related to those advertisers and hence allow the targeted ad to be displayed. The user would have the option to turn this feature off or decide which pieces of his own data he wants to match against a particular advertiser's database. This creates a permission-based system where the user has control over which advertising networks may match with his or her data.

This invention solves any privacy concerns of a user, while keeping the ability for a website or social network to still sell targeted advertisements that are relevant to the particular user.

It is understood that the present invention may take many forms and embodiments. Accordingly, several variations may be made in the foregoing without departing from the spirit or the scope of the invention. For example, using other server types such as FTP servers instead of Web servers, private networks instead of the Internet, and the like.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments.

1. A distributed advertising system comprising:
a network server computer having a web server adapted for running a web application having access to advertiser metadata and other advertiser data;
a client computer comprising:
first software configured to collect and save in first memory user data locally in a user device, but not send that data to the server computer;
second software configured to download via the network from the web server and save in a first memory advertiser metadata in a manner where the entire advertiser metadata file needs to be downloaded every time; and
third software configured, when accessing a website or social network, to match local data against the local copy of advertiser metadata residing at the user's device, and if there are desirable advertisers to display, to download parts of the other advertiser data related to those advertisers and display one or more targeted ads.
